(19) United States
(12) Patent Application Publication
(10) Pub. No.: US 2025/0278902 A1
(43) Pub. Date: Sep. 4, 2025

(54) TECHNIQUES FOR COORDINATING ARTIFICIAL-REALITY INTERACTIONS USING AUGMENTED-REALITY INTERACTION GUIDES FOR PERFORMING INTERACTIONS WITH PHYSICAL OBJECTS WITHIN A USER'S PHYSICAL SURROUNDINGS, AND SYSTEMS AND METHODS FOR USING SUCH TECHNIQUES

(71) Applicant: Meta Platforms Technologies, LLC, Menlo Park, CA (US)

(72) Inventors: Jared Lodwick, Foster City, CA (US); John Jacob Blakeley, Bothell, WA (US); Neetika Bachlaus, San Francisco, CA (US); Christopher Law, San Francisco, CA (US); Hsin-Yao Lin, San Jose, CA (US); Michael James Borke, Orange, CA (US); Tianpei Luo, San Jose, CA (US); Fangwei Lee, San Carlos, CA (US)

(21) Appl. No.: 19/067,789

(22) Filed: Feb. 28, 2025

Related U.S. Application Data
(60) Provisional application No. 63/560,439, filed on Mar. 1, 2024.

(51) Int. Cl. G06T 19/00; G06F 3/01; G06F 3/0346

(52) U.S. Cl. CPC G06T 19/006; G06F 3/011; G06F 3/0346

(57) ABSTRACT

A method of coordinating artificial-reality (AR) interactions by presenting augmented-reality interaction guides is provided. The method includes, after receiving a user input requesting an augmented-reality assisted interaction to be directed to a physical surface, presenting, via the AR headset, an augmented-reality interaction guide that is (i) co-located with the physical surface, and (ii) presented with a first orientation relative to the AR headset. The method includes obtaining data indicating that a user interaction has caused a modification to the physical surface. And the method includes, responsive to obtaining additional data, via the AR headset, indicating movement of the physical surface relative to the orientation of the AR headset: presenting the augmented-reality interaction guide to appear at the physical surface with a second orientation relative, different than the first orientation. The second orientation is determined based on: the modification to the physical surface, and the movement of the physical surface.

### CROSS-REFERENCE TO RELATED APPLICATION

The present Application claims priority to U.S. Provisional Patent Application No. 63/560,439, filed Mar. 1, 2024, entitled “Techniques for Coordinating Artificial-Reality Interactions Using Augmented-Reality Interaction Guides for Performing Interactions with Physical Objects Within a User's Physical Surroundings, and Systems and Methods for Using Such Techniques,” which is hereby incorporated by reference in its entirety for all purposes.

### TECHNICAL FIELD

The present disclosure relates generally to wearable electronic devices (e.g., head- wearable devices, such as augmented-reality headsets), and specifically to techniques for coordinating artificial-reality (AR) interactions using (e.g., by causing presentation of) visual interaction guides for user-performed interactions with physical objects within a user's physical surroundings, and systems and methods for using such techniques.

### BACKGROUND

AR headsets and related systems are increasingly becoming popular for users of electronic devices. Such AR systems can be used to interact with immersive AR content that is presented so as to substantially encompass a field of view of the user of the AR system (e.g., content related to a virtual metaverse “world” that the user is interacting with using the AR device), and/or augmented-reality content that includes a substantially unobstructed portion of a user's field of view, such that the user can see an unobstructed portion of their physical surroundings (e.g., directly or via passthrough imaging data).

There are also some current systems available that allow for interactions with physical objects in a user's physical surroundings, such as guided sketching applications. However, current solutions for such systems have drawbacks. For example, some systems for implementing such interactive experiences require complex and tedious steps for maintaining alignment between the physical object that is being drawn on (e.g., the piece of paper) and the computing device (e.g., a mobile phone or tablet) that is being used to guide the interaction.

As such, there is a need to address one or more of the above-identified challenges. A brief summary of solutions to the issues noted above are described below.

### SUMMARY

Users of AR systems may wish to use AR content while interacting with substantially unobstructed portions of their physical surroundings in a relatively unintrusive way that does not make them feel removed or pre-occupied from their physical surroundings. The methods, systems, and devices described herein allow users wearing AR headsets to engage with AR content designed for facilitating such user interactions with one or more physical objects within the user's physical environment. For example, some embodiments described herein allow users to interact with a physical surface using an AR interaction guide that is presented at a location on the physical surface with a particular orientation based on an orientation of the user's AR headset (e.g., an orientation with respect to the physical surface). In other words, a visual presentation of the augmented-reality interaction guide may be modified based on movement by the user, or one of the physical objects that the user is using in conjunction with the augmented-reality interaction guide, such that a same visual correspondence is maintained at the physical object (e.g., a surface portion of a piece of paper) to provide a smooth, efficient, and intuitive experience for the user while they are performing the AR interaction using the augmented-reality interaction guide.

One example method for coordinating AR interactions by causing presentation of AR interaction guides for performing interactions with physical objects within a user's physical surroundings is described herein. The example method includes operations for, responsive to receiving, at an AR headset, a user input requesting an augmented-reality-assisted interaction guide to be directed to a physical surface (e.g., a surface of a piece of paper that is within a field of view of the user), presenting, via the AR headset, an augmented-reality interaction guide that is (i) co-located with the physical surface, and (ii) presented within a first orientation relative to an orientation of the AR headset. The method includes obtaining data, via the AR headset, indicating that a user interaction has been performed that causes a modification to the physical surface. And the method includes, responsive to obtaining additional data, via the AR headset, indicating movement of the physical surface relative to the orientation of the AR headset, presenting, via the AR headset, the augmented-reality interaction guide so that it appears at the physical surface with a second orientation relative to the orientation of the AR headset, different than the first orientation. The second orientation is determined based on: (i) the modification to the physical surface caused by the user interaction at the physical surface, and (ii) the movement of the physical surface relative to the orientation of the AR headset.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A to 1J illustrate an example interaction between a user and an AR system where the AR system is causing an augmented-reality interaction guide to be presented in proximity to a physical object in the physical surroundings of the user, in accordance with some embodiments.

FIG. 2 shows an example method flow chart for coordinating AR interactions by causing presentation of visual interaction guides for user-performed interactions with physical objects within a user's physical surroundings, in accordance with some embodiments.

FIGS. 3A-3C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramar (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

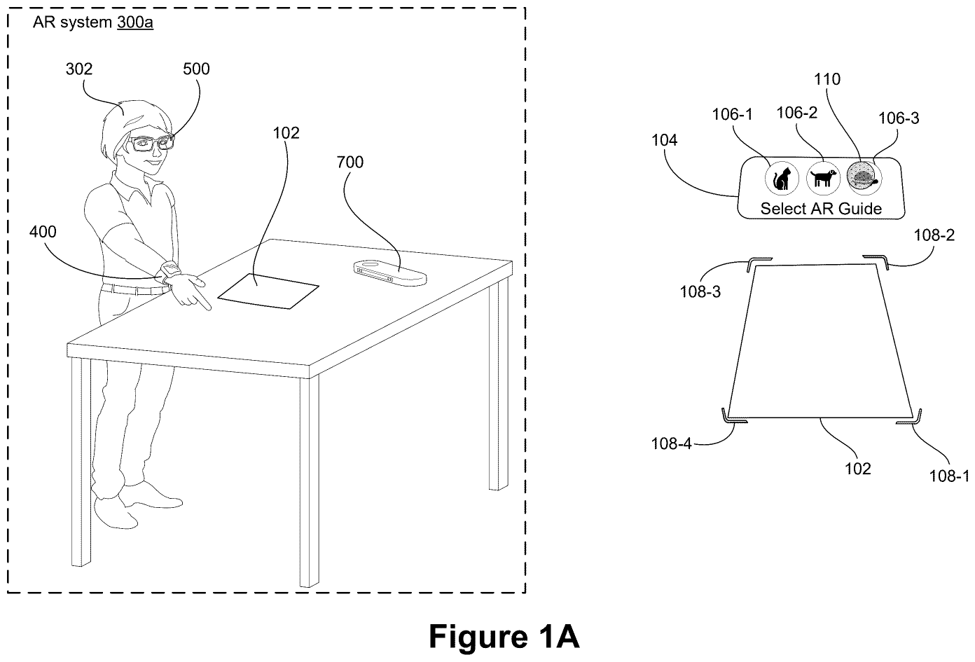

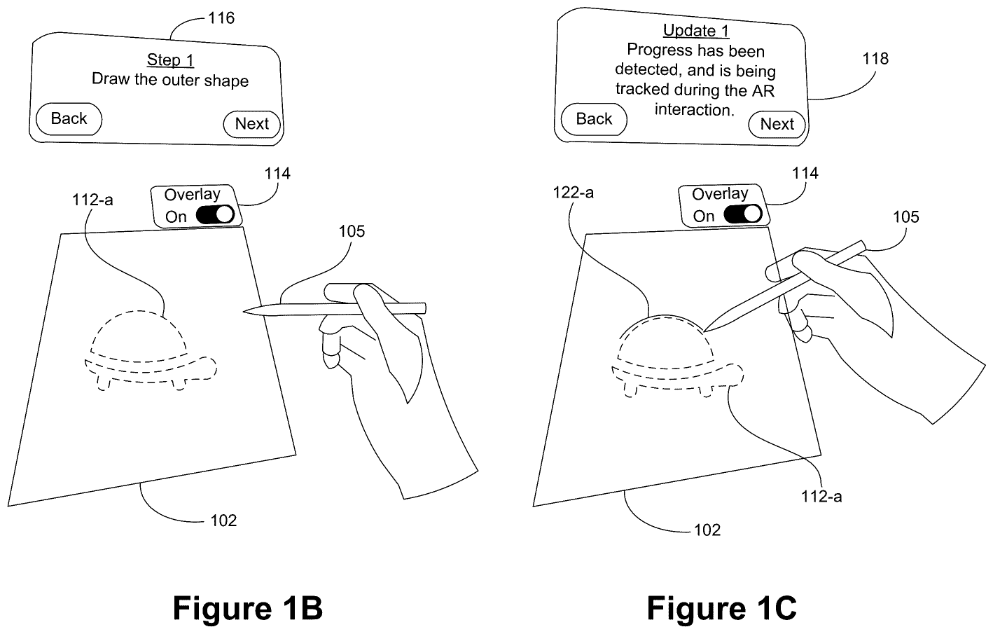

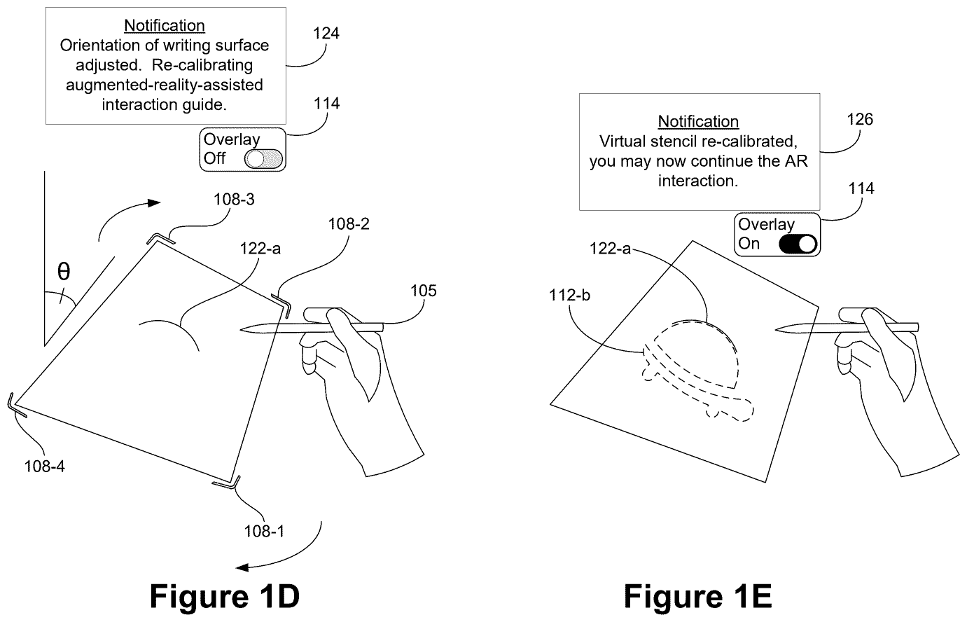

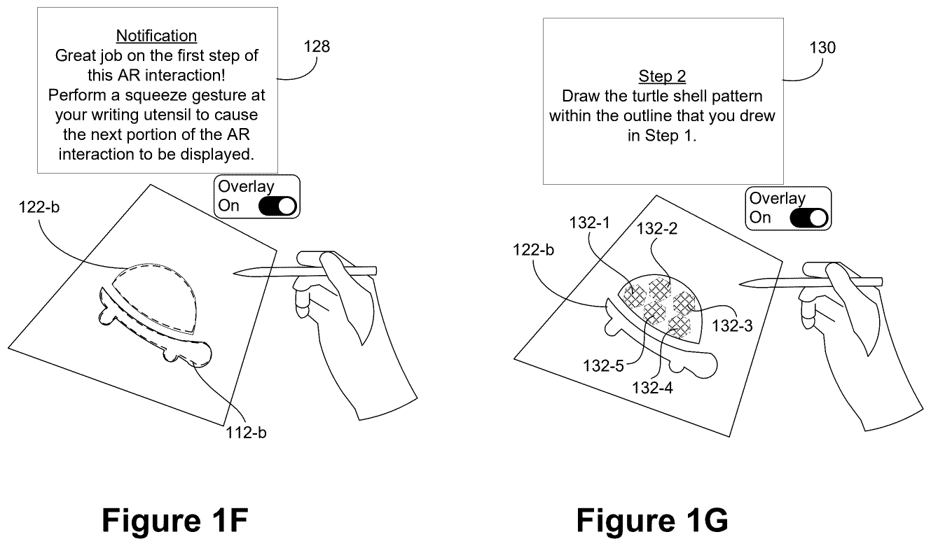

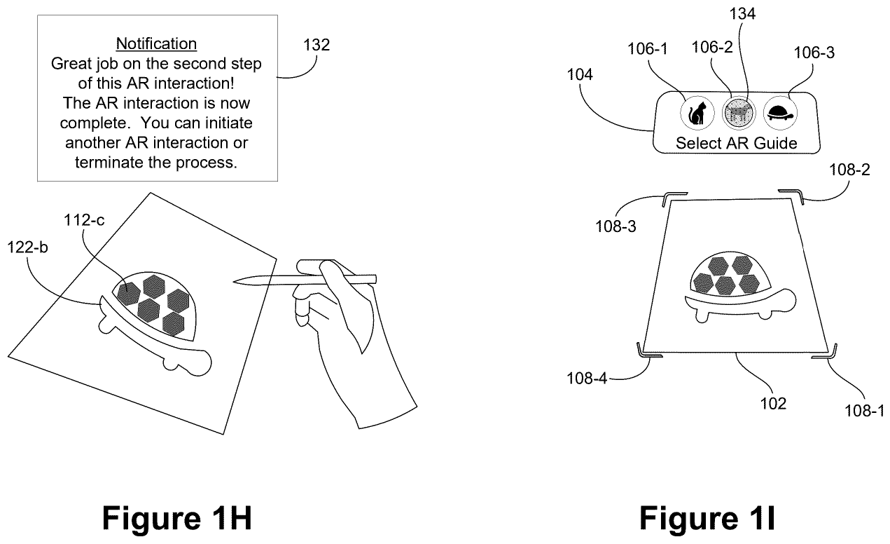

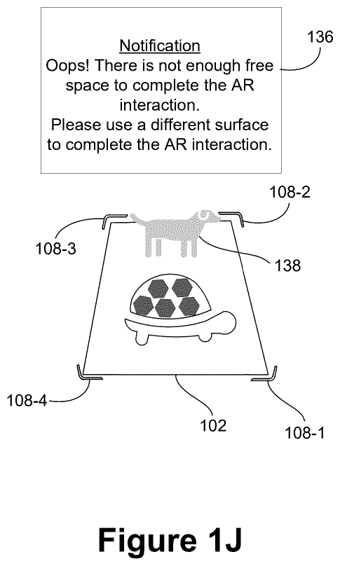

FIGS. 1A to 1J illustrate an example interaction between a user and an AR system where the AR system is causing an augmented-reality interaction to be presented in proximity to a physical object in the physical surroundings of the user, in accordance with some embodiments.

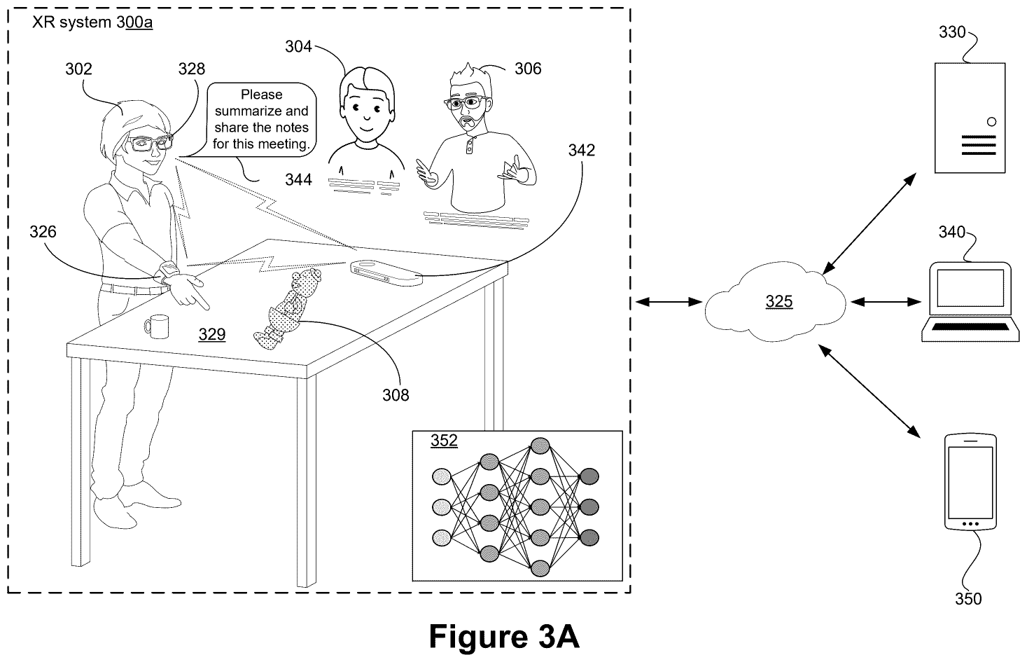

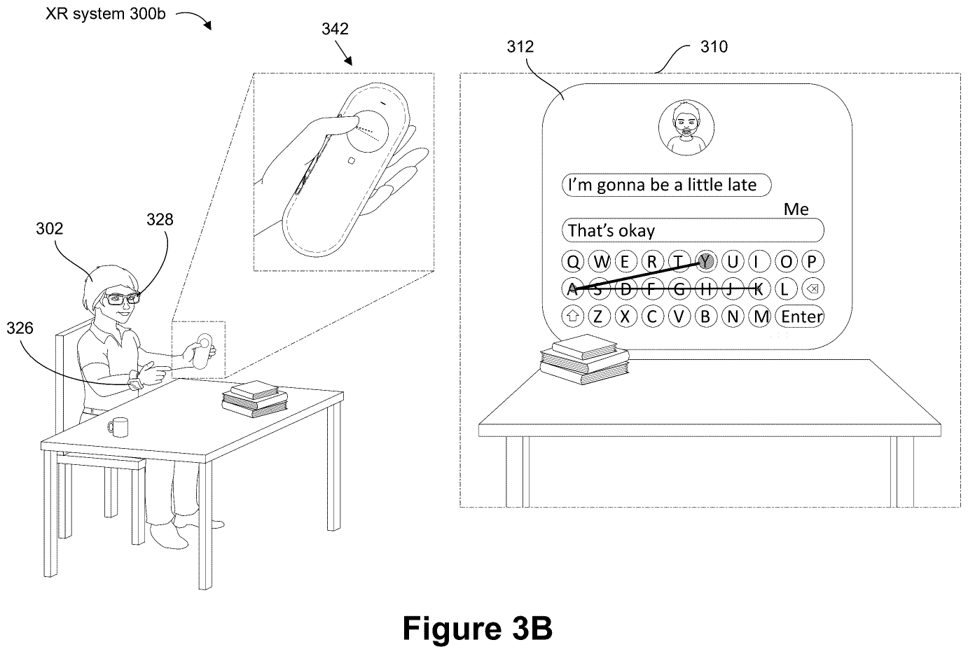

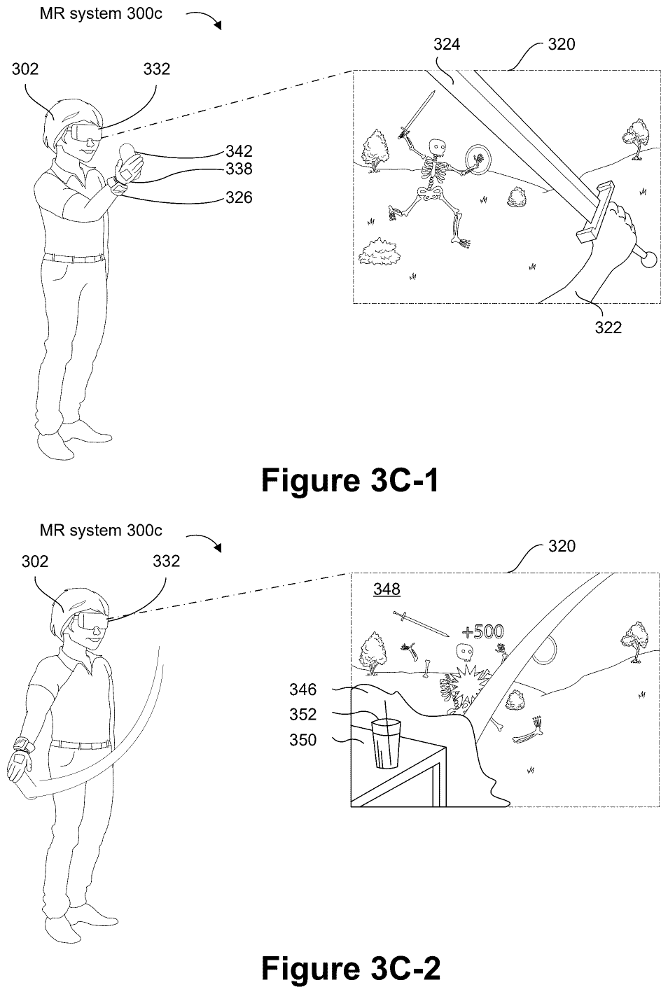

FIG. 1A shows the user 302 interacting with an AR system 300a, which includes the AR device 328, which is configured to present AR and AR content to the user 302 (e.g., user interface elements overlayed onto physical objects within physical surroundings (e.g., a physical piece of paper 102 on the desk in front of the user 302)). The AR system 300a also includes accessory components (e.g., one or more components that may or may not be used for presenting visual AR content to the user), which can be used in conjunction with the systems and methods described herein. For example, the AR system 300a includes a wrist-wearable device 326 that can be used to detect gestures performed by the user 302 (e.g., predefined in-air hand gestures corresponding to user commands to be performed by the AR system 300a, and/or natural hand movements performed by the user 302 while they are interacting with their physical surroundings). In some embodiments, gestures are detected by the wrist-wearable device 326 and/or the AR device 328 alone or in conjunction with one another. In some embodiments, the AR system 300a includes and handheld intermediary processing device 342 (or other device described below in reference to FIG. 3A) that can be used in conjunction with the wrist-wearable device 326 and/or the AR device 328 to perform the one or more functions described below.

As shown in FIG. 1A, the AR device 328 presents visual AR content, including a plurality of user interface elements associated with an AR interaction for coordinating an interaction by the user 302 with the physical piece of paper 102. For example, the AR device 328 presents a user interface element 104, which includes information about the AR interaction (e.g., “Select AR Guide”). Specifically, the user interface element 104 includes a list of options (e.g., virtual stencil objects 106-1, 106-2, and 106-3), which the user 302 can select to use in conjunction with performing the AR interaction. In some embodiments, the list of options presented within the user interface element 104 is based on one or more characteristics of one or more physical objects (e.g., the piece of paper 102, and/or a particular drawing utensil (e.g., a pen, a paintbrush, smart textile-based garments 338)) that the user 302 is using to interact with the piece of paper 102 and/or has available (e.g., within a user's reach). For example, the options presented by the AR device 328 are identified based on a size of the piece of paper 102 (e.g., such that they fit within an interactable portion of the piece of paper 102 or a portion that is available or not filled in).

In addition to the user interface element 104, a set of user interface elements 108-1, 108-2, 108-3, and 108-4 is presented at respective corners of the piece of paper 102. In accordance with some embodiments, such user interface elements 108-1 to 108-4 are boundary user interface elements for assisting the interaction by the user 302 with the piece of paper 102 (e.g., to help the user to draw within the surface of the piece of paper 102 to avoid damaging any of the physical surroundings aside from those being used as part of the AR interaction). In some embodiments, the boundary user interface elements 108-1 to 108-4 identify a portion of the piece of paper 102 as a workable area (e.g., to avoid any text, images, or other information included on the piece of paper 102. In accordance with some embodiments, one or more guide user interface elements (e.g., the user interface element 104 and/or virtual stencil objects 106) are displayed when the user 302 or the interaction implement that the user 302 is using is within a threshold distance of a boundary of the interaction surface identified for the augmented-reality-assisted interaction being performed by the user 302. The boundary user interface elements 108-1 to 108-4 can be used to identify a working area for the user 302. If the working area is not accurate or the user 302 wishes to identify a larger working area, the user 302 can place the boundary user interface elements 108-1 to 108-4 to identify the available area for interaction.

The user 302 can perform an in-air hand gesture to select (e.g., using a focus selector 110 that tracks a hand and/or gaze of the user 302) the virtual stencil 106-3 for performing the augmented-reality-assisted interaction. For example, the user 302 may perform a pointing gesture with their index finger directed to the location of the option for the virtual stencil 106-3. In accordance with some embodiments, the AR system 300a can detect whether the user 302 is holding an interaction implement in one of their hands (e.g., holding the pen 105), and can responsively ignore hand movements that would otherwise be recognized as in-air hand gestures when those gestures are performed by the particular hand that is holding the interaction implement (e.g., the pen 105). Alternatively, or in addition, in some embodiments, the AR system 300a detects a distinct set of hand gestures by the particular hand that is holding the interaction implement. For example, hand gestures detected by the hand that is holding the interaction implement can be used to change configurations of the virtual stencil and/or guide (e.g., line thickness, line colors, line dashes, etc.).

In some embodiments, the options to be presented by the AR device are identified based on detecting a type of interaction implement (e.g., a writing utensil, such as a pen or pencil) that is detected in the physical surroundings of the user 302. For example, as shown in FIG. 1B, the user 302 may be holding or capable of holding a pen that is within reach of the user 302 (e.g., in their physical surroundings), and the AR system 300a may responsively present augmented-reality interaction guides to the user 302, where each of the augmented-reality interaction guides are capable of being executed with the pen 105.

FIG. 1B further shows another portion of the sequence, after the user 302 has selected the virtual stencil 106-3 for performing the AR interaction. Based on the selection of the virtual stencil 106-3 by the user 302, the AR system 300a causes presentation of a visual representation 112-a of the virtual stencil 106-3 via the AR device 328 such that the visual representation 112-a of the virtual stencil 106-3 appears on a portion of the surface of the piece of paper 102. An orientation for presenting the visual representation 112-a is identified based on a relative orientation of the AR device 328 that the user 302 is wearing, in accordance with some embodiments. In some embodiments, the AR system 300a performs an operation to determine a semantic orientation of the physical object that the user 302 is writing on (e.g., an upward direction of the piece of paper), and the orientation of the virtual stencil 106-3 is determined based on the identified semantic orientation of the physical object, the orientation of the AR device, and/or a predefined semantic orientation of the virtual stencil 106-3.

In some embodiments, an overlay user interface element 114 is presented via the AR device 328. The overlay user interface element 114 includes a textual description relating to the AR interaction (e.g., text stating: “Overlay On”) and an interactive user interface element that the user can toggle to hide or display the visual representation of the virtual stencil 106-3. The AR device 328 can also present an instructions user interface element 116. The instructions user interface element 116 includes a textual notification to the user 302 related to the AR interaction (stating “Step 1: Draw the outer shape”). The instructions user interface element 116 further includes textual user interface elements for causing operations to be performed at the AR system 300a. For example, the user may select the selectable “Back” user interface element to cause the AR system to return to presenting the user interface elements shown in FIG. 1A, including the user interface 104 for selecting an augmented-reality interaction guide.

FIG. 1C shows another view of the sequence illustrated by FIGS. 1A to 1J. And in particular, FIG. 1C shows a point in time after the user 302 has begun interacting with the physical surroundings, including the physical object (i.e., the piece of paper 102) that is being targeted for the augmented-reality-assisted interaction. FIG. 1C shows that the user 302 has made progress markings 122-a on the piece of paper 102 as part of the performing the augmented- reality-assisted interaction at the AR system 300a. As described herein, progress markings are any physical modifications to the physical object that the user 302 is interacting with as part of the augmented-reality-assisted interaction. In some embodiments, the AR device 328 presents a progress tracker user interface element 118 including a textual notification for the user 302. The progress tracker user interface element 118 includes a description of the user 302's inputs or the progress in competing the AR interaction (e.g., “Update 1: Progress has been detected, and is being tracked during the AR interaction.”).

Based on the user 302 adjusting the orientation of the piece of paper 102, the AR systems 300a ceases to present the visual representation 112-a corresponding to the virtual stencil 106-3, which may be performed to notify the user 302 to suspend performance of the augmented-reality-assisted interaction while the orientation of the augmented-reality interaction guide is being adjusted based on the progress markings and the adjusted orientation of the physical object with respect to the AR device 328.

FIG. 1D shows another view of the sequence illustrated by FIGS. 1A to 1J. And in particular, FIG. 1D shows a point in time after the user 302 has adjusted (e.g., rotated) the piece of paper 102 such that the piece of paper 102 has a different orientation relative to the orientation of the AR device 328. As further shown in FIG. 1D, the overlay user interface element 114 is toggled off (e.g., text stating: “Overlay Off”) to notify the user 302 that the visual representation 112 corresponding to the virtual stencil 106-3 is not available during the re-calibration process. In some embodiments, the AR device 328 presents a calibration notification user interface element 124 including a textual notification for the user 302. The calibration notification user interface element 124 includes a description of the unavailability of the visual representation 112 corresponding to the virtual stencil 106-3 while re-calibration is in process.

FIG. 1E shows another view of the sequence illustrated by FIGS. 1A to 1J. And in particular, FIG. 1E shows a point in time after the user 302 has performed the adjustment of the piece of paper 102 to modify the relative orientation between the piece of paper 102 and the AR device 328. The visual representation 112-b of the virtual stencil 106-3 is presented with an adjusted orientation relative to the orientation of the AR device 328 based on the adjusted orientation of the piece of paper 102. In accordance with some embodiments, the AR system 300adetermines the proper modification to the visual representation 112-b based on (i) the difference (e.g., θ; shown in FIG. 1D) in orientation of the piece of paper 102, and/or (ii) the progress markings 122-b on the piece of paper 102 caused by the interaction by the user 302 with the AR system 300a. In some embodiments, the AR device 328 presents an updated calibration notification user interface element 126 including a textual notification for the user 302. The updated calibration notification user interface element 126 includes a description that the re-calibration is complete and the visual representation 112 corresponding to the virtual stencil 106-3 is available.

FIG. 1F shows another view of the sequence illustrated by FIGS. 1A to 1J after the user has modified the progress markings 122-b further from the progress markings shown in FIGS. 1C to 1E. In accordance with some embodiments, based on the adjustment to the progress markings 122-b, the AR system 300a identifies that the user 302 has completed a portion of the augmented-reality-assisted interaction, and that augmented-reality interaction guide should be adjusted based on the progress that the user 302 (e.g., based on comparing the progress markings 122-b to data related to the augmented-reality interaction guide (e.g., the virtual stencil 106-3)). In some embodiments, the AR device 328 presents an updated progress tracker user interface element 128 including a textual notification for the user 302. The updated progress tracker user interface element 128 includes a description of the steps completed by the user 302 and identifies subsequent steps or actions (e.g., “Notification: Great job on the first step of this AR interaction! Perform a squeeze gesture at your writing utensil to cause the next portion of the AR interaction to be displayed.”).

FIG. 1G shows another view of the sequence illustrated by FIGS. 1A to 1J after the user has completed the first portion of the AR interaction, and the AR device 328 presents visual elements (e.g., via the AR device 328) of a different augmented-reality interaction guide (e.g., a set of visual representations 132-1, 132-2, 132-3, 132-4, and 132-5). That is, in accordance with some embodiments, after the AR system 300 determines that the user 302 has completed a portion of the AR interaction, the AR system 300 is configured to identify another portion of the AR interaction for the user 302 to perform, and determines how to present another augmented-reality interaction guide that corresponds to the new portion of the AR interaction, based on at least (i) the progress markings that the user 302 has created on the physical object based on the performed portion of the AR interaction, and (ii) the orientation of the physical object (e.g., the piece of paper) with respect to an orientation of the AR device 328.

In accordance with some embodiments, the visual representation of the other augmented-reality interaction guide may be determined based, at least in part, on the locations of the progress markings from the first portion of the AR interaction. For example, as shown in FIG. 1G, the set of visual representations 132-1, 132-2, 132-3, 132-4, and 132-5 are presented within a portion (e.g., a shell) of the visual representation 112 corresponding to the virtual stencil 106-3. The AR device 328 can also present updated instructions user interface element 130. The updated instructions user interface element 130 includes a textual notification to the user 302 related to the subsequent AR interaction (stating “Step 2: Draw the turtle shell pattern within the outline that you drew in Step 1.”).

FIG. 1H shows yet another view of the sequence illustrated by FIGS. 1A to 1J after the user has completed the AR interaction. In particular, AR system 300a determines that the user 302 has completed the augmented-reality-assisted interaction. The AR system 300a recommends additional actions that the user 302 can perform after completing the augmented-reality-assisted interaction. For example, the AR device 328 presents another updated progress tracker user interface element 132 including a textual notification for the user 302. The other updated progress tracker user interface element 132 includes a description of the completed action and identifies subsequent steps or actions (e.g., “Notification: Great job on the second step of this AR interaction! The AR interaction is now complete. You can initiate another AR interaction or terminate the process.”).

FIG. 1I shows the user 302 opting to initiate another augmented-reality interaction guides. In particular, the user 302 selects, via the user interface element 104 using focus selector 134, the virtual stencil 106-2 for performing the augmented-reality-assisted interaction.

In FIG. 1J, the AR system 300a performs operations analogous with FIGS. 1A and 1B and analyzes the user 302's environment for causing presentation of the other augmented-reality-assisted interaction. The AR system 300a causes presentation of another visual representation 138 of the virtual stencil 106-2 via the AR device 328 such that the visual representation 138 of the virtual stencil 106-2 appears on a portion of the surface of the piece of paper 102. In FIG. 1J, the AR system 300a determines that the piece of paper 102 (e.g., the user 302's working space or physical surface) does not include enough space to allow for the visual representation 138 of the virtual stencil 106-2 to be drawn. As such, the AR system 300a does not initiate the augmented-reality-assisted interaction and causes presentation, via the AR device 328, of an additional updated instructions user interface element 136. The additional updated instructions user interface element 136 includes a textual notification to the user 302 related to the other augmented-reality-assisted interaction (stating “Notification: Oops! There is not enough free space to complete the AR interaction. Please use a different surface to complete the AR interaction.”). The user 302 can perform the suggested actions to initiate the other augmented- reality-assisted interaction.

While the examples provided above in reference to FIGS. 1A-1J describe an AR system for guiding an augmented-reality-assisted interaction using pen and paper, the above the augmented-reality-assisted interaction can be used with other mediums. For example, the augmented-reality-assisted interaction can be performed with an AR device 328, a tablet, and a stylus; an AR device 328, a whiteboard and dry-erase markers; a wrist-wearable device 326, and a tablet; a AR device 328, a wrist-wearable device 326, and an AR writing space; an AR device 328, a paintbrush, and canvas; and/or any other combination of devices described below in reference to FIG. 3A.

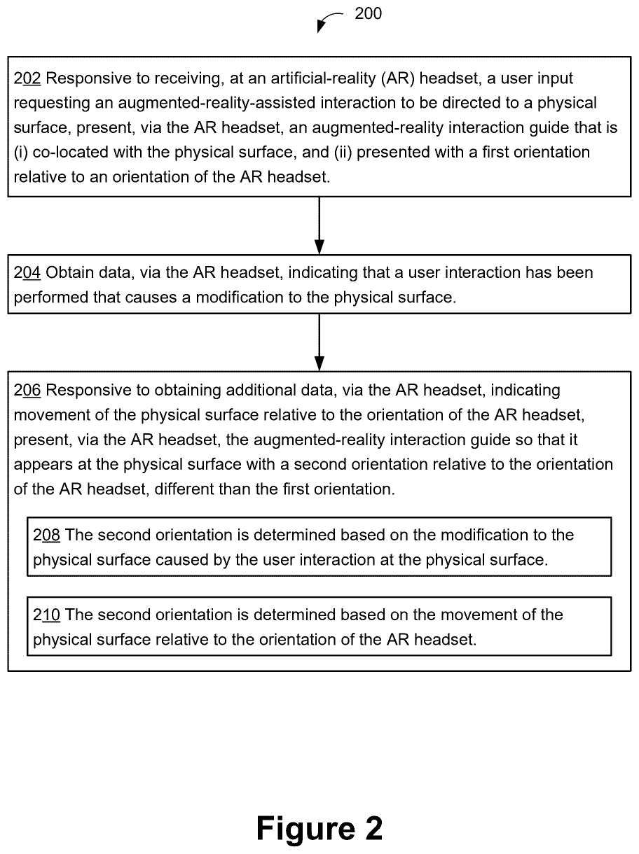

FIG. 2 illustrates a flow diagram of an example method 200 for coordinating AR interactions by causing presentation of visual interaction guides for user-performed interactions with physical objects within a user's physical surroundings, in accordance with some embodiments. Operations (e.g., steps) of the method 200 can be performed by one or more processors (e.g., central processing unit and/or MCU) of an AR system 300. At least some of the operations shown in FIG. 2 correspond to instructions stored in a computer memory or computer-readable storage medium (e.g., storage, RAM, and/or memory), for example, programming code for causing the operations to be executed may be stored at memory 550A of the AR device 328 or the VR device 510.

Operations of the method 200 can be performed by a single device alone or in conjunction with one or more processors and/or hardware components of another communicatively coupled device (e.g., a wrist-wearable device 326, a handheld intermediary processing device 342, and/or smart textile-based garments 338) and/or instructions stored in memory or computer-readable medium of the other device communicatively coupled to the AR system 300. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(A1) The method 200 includes, responsive to receiving, at an AR headset (e.g., the AR device 328, or the VR device 510), a user input requesting an augmented-reality-assisted interaction to be directed to a physical surface (e.g., a request to present an AR drawing guide (e.g., a virtual stencil) onto a physical surface of the piece of paper 102, as illustrated by the hand gesture in FIG. 1A), presenting (202), via the AR headset, an augmented-reality interaction guide that is (i) co-located with the physical surface, and (ii) presented with a first orientation relative to an orientation of the AR headset (and/or relative to a present orientation of the physical surface relative to the AR headset). For example, as shown in FIG. 1B, the augmented-reality interaction guide 112 is presented on the surface of the piece of paper 102 such that it is vertically and horizontally centered in the paper and is also rotationally aligned with the orientation of the piece of paper 102 relative to the AR device 328.

The method 200 includes obtaining (204) data, via the AR headset, indicating that a user interaction has been performed that causes a modification to the physical surface (e.g., drawing with a pencil on the piece of paper 102, as shown by the pencil marking 122 shown in FIG. 1C). For example, one or more imaging sensors 526 of the AR device 328 that the user 302 is wearing in the sequence illustrated by FIGS. 1A to 1J. In accordance with some embodiments, one or more imaging sensors 654 of the HIPD 600 may be obtaining imaging data of the piece of paper 102 and communicating with the AR device 328.

The method 200 includes, responsive to obtaining additional data, via the AR headset, indicating movement of the physical surface relative to the orientation of the AR headset (e.g., the user 302 rotating the piece of paper, as illustrated by FIG. 1D), presenting (206), via the AR headset, the augmented-reality interaction guide so that it appears at the physical surface with a second orientation relative to the orientation of the AR headset, different than the first orientation (e.g., presenting the augmented-reality interaction guide 112 with the second orientation corresponding to the new orientation of the piece of paper 102, as shown in FIG. 1E). It should be noted that, although the embodiments described with respect to FIGS. 1A to 1G focus on operations that are based on an indication of movement of a physical surface (e.g., the surface of the piece of paper 102), it will be apparent to one of skill in the art that other movements may be relevant for performing the orientation adjustment operations described herein.

The second orientation is determined based on the modification to the physical surface caused by the user interaction at the physical surface (e.g., a portion of writing on the surface of the piece of paper 102 that the user 302 has performed while the augmented-reality interaction guide is being presented by the AR device 328) (208). And the second orientation is determined based on the movement of the physical surface relative to the orientation of the AR headset (210). For example, as shown in FIG. 1E, the augmented-reality interaction guide (e.g., visual representation 112-b of the virtual stencil 106-3) is presented at a different angle with respect to the AR device 328 based on the user 302 rotating the piece of paper 102 on the desk. And the augmented-reality interaction guide 112 is presented at a location on the piece of paper 102 such that the augmented-reality interaction guide 112 is aligned with markings 122 that the user 302 has already made on the surface of the piece of paper 102 as part of following the augmented-reality interaction guide 112.

(A2) In some embodiments of A1, the method 200 includes, before presenting the augmented-reality interaction guide, obtaining object data about the physical surface and/or a physical object having the physical surface (e.g., identifying a surface texture, a surface type, and/or an area of the surface that does not include any visual markings prior to the user using the augmented-reality interaction guide), and identifying the augmented-reality interaction guide based on the object data about the physical surface and/or the physical object (e.g., the piece of paper 102).

(A3) In some embodiments of A2, the method 200 includes, after identifying the augmented-reality interaction guide based on the object data, presenting, via the AR headset, an interaction guide selector user interface element that includes the augmented-reality interaction guide (e.g., the user interface element 104 shown in FIG. 1A). For example, the interaction guide selector user interface 104 shown in FIG. 1A includes a plurality of options of augmented-reality interaction guides (e.g., an augmented-reality interaction guide 106-1, an augmented-reality interaction guide 106-2, and/or an interaction guide 106-3), where each of the options of artificial-reality interaction guides may be identified for selection by the user based on data obtained about the surface of the piece of paper 102 that the user 302 is interacting with.

(A4) In some embodiments of any one of A1 to A3, the method 200 includes, responsive to another user input, directed to the physical surface, to cause a different augmented-reality-assisted interaction to be directed to the physical surface, determining that the physical surface is unsuitable for the different augmented-reality-assisted interaction. For example, the previews corresponding to the augmented-reality interaction guide 106-1 to 106-3 presented within the user interface element 104 may be identified to be presented based on one or more characteristics of the physical object (e.g., the piece of paper 102) that the user is using to perform the augmented-reality-assisted interaction. And the method 200 includes, based on determining that the physical surface is unsuitable for the different augmented-reality interaction, forgoing causing the different augmented-reality-assisted interaction to be directed to the physical surface.

In accordance with some embodiments, the determination that the physical surface is unsuitable for the augmented-reality-assisted interaction is based on comparing one or more physical aspects of the physical surface to one or more interactivity criteria related to the augmented-reality assisted interaction. For example, an interactivity criterion may be based on whether the physical surface includes a large enough surface area (e.g., that does not already include writing or other demarcations) such that the augmented-reality-assisted interaction cannot be performed on the physical surface. For example, in accordance with some embodiments, the AR system 300a may determine that the user 302 has already drawn on one or more portions of the piece of paper 102 such that there is no room on the paper for performing the augmented-reality-assisted interaction.

(A5) In some embodiments of A4, forgoing causing the different augmented- reality-assisted interaction to be performed at the physical surface includes forgoing presenting a respective augmented-reality interaction guide, corresponding to the different augmented-reality interaction guide, to appear at the physical surface.

(A6) In some embodiments of A4, the method 200 includes, in accordance with forgoing presenting the respective augmented-reality interaction guide based on determining that the physical surface is unsuitable for the different augmented-reality-assisted interaction, presenting an indication that the physical surface is unsuitable for the different augmented-reality-assisted interaction. For example, in FIG. 1J a notification is presented to the user 302 indicating that the user is unable to use the requested augmented-reality interaction guide to cause the interaction to be performed based on a respective size (e.g., a surface area) on the surface of the piece of paper 102 that is less than required for performing the augmented-reality-assisted interaction that is configured to be facilitated by the selected augmented-reality interaction guide.

(A7) In some embodiments of any one of A1 to A6, the augmented-reality-assisted interaction includes one or more of (i) painting, (ii) calligraphy, (iii) graffiti, and/or (iv) cut-out patterns. In accordance with some embodiments, the suitability of the physical object for performing the augmented-reality-assisted interaction is based on the type of augmented-reality-assisted interaction that the user 302 is attempting to perform. For example, the AR system 300a may determine that a whiteboard in the user's physical surroundings is suitable for performing a first type of interaction (e.g., drawing), but is not suitable for a different type of interaction (e.g., painting, origami).

(A8) In some embodiments of any one of A1 to A7, the method 200 includes determining, based on obtaining additional surface data about the physical surface, that a portion of the augmented-reality-assisted interaction facilitated by the augmented-reality interaction guide has been completed. And the method 200 includes, based on determining that the portion of the augmented-reality-assisted interaction has been completed, adjusting the presenting of the augmented-reality interaction guide to present respective visual elements corresponding to a different portion of the augmented-reality interaction guide. For example, data about the surface of the physical object that the user is writing on may indicate that the user has completed some portion of a drawing that is configured to be drawn by the augmented-reality interaction guide, such that the user is ready to start drawing a different portion of the drawing that requires a different augmented-reality interaction guide (or portion thereof) to be presented to be co-located at a portion of the piece of paper 102.

(A9) In some embodiments of any one of A1 to A7, the method 200 includes, at a first time, before the augmented-reality interaction guide is being presented via the AR headset, presenting a first visual representation of a hand of a user of the AR headset. And the method 200 includes, at a second time while the augmented-reality interaction guide is being presented, presenting a second visual representation of the hand of the user, wherein the second visual representation of the hand of the user is different than the first visual representation of the hand of the user. In other words, in some embodiments, the look-and-feel of the augmented-reality visualization of the user's hands can be adjusted based on whether the user is interacting with the augmented-reality interaction guide (e.g., showing a red outline of a portion of the representation of the user's hand to indicate that they are actively drawing on the piece of paper 102).

(A10) In some embodiments of any one of A1 to A9, the method 200 includes presenting respective user interface elements at one or more respective boundaries of an interactable area of the physical surface (e.g., guide corners). And the method 200 includes, based on obtaining the additional data indicating the movement of the physical surface relative to the orientation of the AR headset, adjusting the respective user interface elements configured to be presented at the one or more respective boundaries of the interactable area of the physical surface based on the modification of the physical surface relative to the orientation of the AR headset.

(A11) In some embodiments of A10, the method 200 further includes, determining, based on progress data obtained by one or more sensors of the AR headset (e.g., or another device of the AR system that the user 302 is using to perform the AR-assisted interaction), that a respective user interaction with the augmented-reality interaction guide is being performed within a threshold distance of one of the respective boundaries of the interactable area of the physical surface. And the method 200 further includes, based on determining that the respective user interaction is being performed within the threshold distance of one of the respective boundaries, providing a boundary alert indication to the user that the hand is within the threshold distance of the one of the respective boundaries.

(A12) In some embodiments of any one of A1 to A11, the data obtained via the AR headset indicating that the user performed the augmented-reality-assisted interaction at the physical surface includes passthrough data from an imaging sensor on a forward-facing surface of the AR headset. And the modification to the physical surface is identified by comparing the passthrough data from the imaging sensor to previous passthrough data of the physical surface from before the user began performing the augmented-reality-assisted interaction.

(A13) In some embodiments of A12, the passthrough data is captured by a plurality of imaging sensors on the forward-facing surface of the AR headset. In some embodiments, the forward-facing surface of the AR headset includes a first side proximal to a first lens of the AR headset, and the forward-facing surface of the AR headset includes a second side proximal to a second lens of the AR headset. In some embodiments, a first imaging sensor of the plurality of imaging sensors is on the first side of the forward-facing surface of the AR headset, and a second imaging sensor of the plurality of imaging sensors is on the second side of the forward-facing surface of the AR headset.

(A14) In some embodiments of A13, the first imaging sensor and the second imaging sensor and the second imaging sensor are separated by at least 7 centimeters.

(A15) In some embodiments of A14, the first imaging sensor and the second imaging sensor are co-planar along a first dimension.

(A16) In some embodiments of any one of A1 to A15, the data indicating the movement of the physical surface relative to the orientation of the AR headset is obtained in accordance with detecting a head movement of the user.

(A17) In some embodiments of A16, the AR headset includes an inertial measurement unit (IMU), and the head movement of the user is detected by the IMU.

(A18) In some embodiments of any one of A1 to A17, a non-coded physical object comprises the physical surface (e.g., a physical object that is not specially coded for use with the drawing guide visual element). In other words, the methods, AR systems, and devices described herein are configured to be used with standard, real-world writing utensils that are not modified for the specific task of identifying and tracking the piece of paper. In accordance with some embodiments, the AR system 300a is configured to detect one or more semantic properties (e.g., functional properties) of the physical object in order to determine information relevant to re-positioning an augmented-reality-interact guide with respect to the physical object.

(A19) In some embodiments of A18, the non-coded physical object is a blank, two-dimensional sheet of paper. In some embodiments, the non-coded physical object is a whiteboard, chalkboard, folding paper, sewing yarn, or other physical object that is configured to be physically crafted by the user's hands.

(B1) In accordance with some embodiments, a system that includes one or more wrist wearable devices and an artificial-reality headset, and the system is configured to perform operations corresponding to any of A1-A19.

(C1) In accordance with some embodiments, a non-transitory computer readable storage medium including instructions that, when executed by a computing device in communication with an artificial-reality headset, cause the computer device to perform operations corresponding to any of A1-A19.

(D1) In accordance with some embodiments, a head-wearable device including one or more processors and memory. The memory including instructions which, when executed by the one or more processors, cause the head-wearable device to perform operations corresponding to any of A1-A19.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

### Example Extended-Reality Systems

FIGS. 3A 3B, 3C-1, and 3C-2, illustrate example XR systems that include AR and MR systems, in accordance with some embodiments. FIG. 3A shows a first XR system 300a and first example user interactions using a wrist-wearable device 326, a head-wearable device (e.g., AR device 328), and/or a HIPD 342. FIG. 3B shows a second XR system 300b and second example user interactions using a wrist-wearable device 326, AR device 328, and/or an HIPD 342. FIGS. 3C-1 and 3C-2 show a third MR system 300c and third example user interactions using a wrist-wearable device 326, a head-wearable device (e.g., an MR device such as a VR device), and/or an HIPD 342. As the skilled artisan will appreciate upon reading the descriptions provided herein, the above-example AR and MR systems (described in detail below) can perform various functions and/or operations.

The wrist-wearable device 326, the head-wearable devices, and/or the HIPD 342 can communicatively couple via a network 325 (e.g., cellular, near field, Wi-Fi, personal area network, wireless LAN). Additionally, the wrist-wearable device 326, the head-wearable device, and/or the HIPD 342 can also communicatively couple with one or more servers 330, computers 340 (e.g., laptops, computers), mobile devices 350 (e.g., smartphones, tablets), and/or other electronic devices via the network 325 (e.g., cellular, near field, Wi-Fi, personal area network, wireless LAN). Similarly, a smart textile-based garment, when used, can also communicatively couple with the wrist-wearable device 326, the head-wearable device(s), the HIPD 342, the one or more servers 330, the computers 340, the mobile devices 350, and/or other electronic devices via the network 325 to provide inputs.

Turning to FIG. 3A, a user 302 is shown wearing the wrist-wearable device 326 and the AR device 328 and having the HIPD 342 on their desk. The wrist-wearable device 326, the AR device 328, and the HIPD 342 facilitate user interaction with an AR environment. In particular, as shown by the first AR system 300a, the wrist-wearable device 326, the AR device 328, and/or the HIPD 342 cause presentation of one or more avatars 304, digital representations of contacts 306, and virtual objects 308. As discussed below, the user 302 can interact with the one or more avatars 304, digital representations of the contacts 306, and virtual objects 308 via the wrist-wearable device 326, the AR device 328, and/or the HIPD 342. In addition, the user 302 is also able to directly view physical objects in the environment, such as a physical table 329, through transparent lens(es) and waveguide(s) of the AR device 328. Alternatively, an MR device could be used in place of the AR device 328 and a similar user experience can take place, but the user would not be directly viewing physical objects in the environment, such as table 329, and would instead be presented with a virtual reconstruction of the table 329 produced from one or more sensors of the MR device (e.g., an outward facing camera capable of recording the surrounding environment).

The user 302 can use any of the wrist-wearable device 326, the AR device 328 (e.g., through physical inputs at the AR device and/or built-in motion tracking of a user's extremities), a smart-textile garment, externally mounted extremity tracking device, the HIPD 342 to provide user inputs, etc. For example, the user 302 can perform one or more hand gestures that are detected by the wrist-wearable device 326 (e.g., using one or more EMG sensors and/or IMUs built into the wrist-wearable device) and/or AR device 328 (e.g., using one or more image sensors or cameras) to provide a user input. Alternatively, or additionally, the user 302 can provide a user input via one or more touch surfaces of the wrist-wearable device 326, the AR device 328, and/or the HIPD 342, and/or voice commands captured by a microphone of the wrist-wearable device 326, the AR device 328, and/or the HIPD 342. The wrist-wearable device 326, the AR device 328, and/or the HIPD 342 include an artificially intelligent digital assistant to help the user in providing a user input (e.g., completing a sequence of operations, suggesting different operations or commands, providing reminders, confirming a command). For example, the digital assistant can be invoked through an input occurring at the AR device 328 (e.g., via an input at a temple arm of the AR device 328). In some embodiments, the user 302 can provide a user input via one or more facial gestures and/or facial expressions. For example, cameras of the wrist-wearable device 326, the AR device 328, and/or the HIPD 342 can track the user 302's eyes for navigating a user interface.

The wrist-wearable device 326, the AR device 328, and/or the HIPD 342 can operate alone or in conjunction to allow the user 302 to interact with the AR environment. In some embodiments, the HIPD 342 is configured to operate as a central hub or control center for the wrist-wearable device 326, the AR device 328, and/or another communicatively coupled device. For example, the user 302 can provide an input to interact with the AR environment at any of the wrist-wearable device 326, the AR device 328, and/or the HIPD 342, and the HIPD 342 can identify one or more back-end and front-end tasks to cause the performance of the requested interaction and distribute instructions to cause the performance of the one or more back-end and front-end tasks at the wrist-wearable device 326, the AR device 328, and/or the HIPD 342. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 342 can perform the back-end tasks and provide the wrist-wearable device 326 and/or the AR device 328 operational data corresponding to the performed back-end tasks such that the wrist-wearable device 326 and/or the AR device 328 can perform the front-end tasks. In this way, the HIPD 342, which has more computational resources and greater thermal headroom than the wrist-wearable device 326 and/or the AR device 328, performs computationally intensive tasks and reduces the computer resource utilization and/or power usage of the wrist-wearable device 326 and/or the AR device 328.

In the example shown by the first AR system 300a, the HIPD 342 identifies one or more back-end tasks and front-end tasks associated with a user request to initiate an AR video call with one or more other users (represented by the avatar 304 and the digital representation of the contact 306) and distributes instructions to cause the performance of the one or more back-end tasks and front-end tasks. In particular, the HIPD 342 performs back-end tasks for processing and/or rendering image data (and other data) associated with the AR video call and provides operational data associated with the performed back-end tasks to the AR device 328 such that the AR device 328 performs front-end tasks for presenting the AR video call (e.g., presenting the avatar 304 and the digital representation of the contact 306).

In some embodiments, the HIPD 342 can operate as a focal or anchor point for causing the presentation of information. This allows the user 302 to be generally aware of where information is presented. For example, as shown in the first AR system 300a, the avatar 304 and the digital representation of the contact 306 are presented above the HIPD 342. In particular, the HIPD 342 and the AR device 328 operate in conjunction to determine a location for presenting the avatar 304 and the digital representation of the contact 306. In some embodiments, information can be presented within a predetermined distance from the HIPD 342 (e.g., within five meters). For example, as shown in the first AR system 300a, virtual object 308 is presented on the desk some distance from the HIPD 342. Similar to the above example, the HIPD 342 and the AR device 328 can operate in conjunction to determine a location for presenting the virtual object 308. Alternatively, in some embodiments, presentation of information is not bound by the HIPD 342. More specifically, the avatar 304, the digital representation of the contact 306, and the virtual object 308 do not have to be presented within a predetermined distance of the HIPD 342. While an AR device 328 is described working with an HIPD, an MR headset can be interacted with in the same way as the AR device 328.

User inputs provided at the wrist-wearable device 326, the AR device 328, and/or the HIPD 342 are coordinated such that the user can use any device to initiate, continue, and/or complete an operation. For example, the user 302 can provide a user input to the AR device 328 to cause the AR device 328 to present the virtual object 308 and, while the virtual object 308 is presented by the AR device 328, the user 302 can provide one or more hand gestures via the wrist-wearable device 326 to interact and/or manipulate the virtual object 308. While an AR device 328 is described working with a wrist-wearable device 326, an MR headset can be interacted with in the same way as the AR device 328.

### Integration of Artificial Intelligence with XR Systems

FIG. 3A illustrates an interaction in which an artificially intelligent virtual assistant can assist in requests made by a user 302. The AI virtual assistant can be used to complete open-ended requests made through natural language inputs by a user 302. For example, in FIG. 3A the user 302 makes an audible request 344 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 3A also illustrates an example neural network 352 used in Artificial Intelligence applications. Uses of Artificial Intelligence (AI) are varied and encompass many different aspects of the devices and systems described herein. AI capabilities cover a diverse range of applications and deepen interactions between the user 302 and user devices (e.g., the AR device 328, an MR device 332, the HIPD 342, the wrist-wearable device 326). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 302 can interact with an AI model through natural language inputs captured by a voice sensor, text inputs, or any other input modality that accepts natural language and/or a corresponding voice sensor module. In another instance, input is provided by tracking the eye gaze of a user 302 via a gaze tracker module. Additionally, the AI model can also receive inputs beyond those supplied by a user 302. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 328) or from multiple devices that are in communication with each other (e.g., a system that includes at least two of an AR device 328, an MR device 332, the HIPD 342, the wrist-wearable device 326, etc.). The AI model can also access additional information (e.g., one or more servers 330, the computers 340, the mobile devices 350, and/or other electronic devices) via a network 325.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 328, an MR device 332, the HIPD 342, the wrist-wearable device 326) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 328, an MR device 332, the HIPD 342, the wrist-wearable device 326), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 342), haptic feedback can provide information to the user 302. An AI model can also use the inputs described above to determine the appropriate modality and device(s) to present content to the user (e.g., a user walking on a busy road can be presented with an audio output instead of a visual output to avoid distracting the user 302).

### Example Augmented Reality Interaction

FIG. 3B shows the user 302 wearing the wrist-wearable device 326 and the AR device 328 and holding the HIPD 342. In the second AR system 300b, the wrist-wearable device 326, the AR device 328, and/or the HIPD 342 are used to receive and/or provide one or more messages to a contact of the user 302. In particular, the wrist-wearable device 326, the AR device 328, and/or the HIPD 342 detect and coordinate one or more user inputs to initiate a messaging application and prepare a response to a received message via the messaging application.

In some embodiments, the user 302 initiates, via a user input, an application on the wrist-wearable device 326, the AR device 328, and/or the HIPD 342 that causes the application to initiate on at least one device. For example, in the second AR system 300b the user 302 performs a hand gesture associated with a command for initiating a messaging application (represented by messaging user interface 312); the wrist-wearable device 326 detects the hand gesture; and, based on a determination that the user 302 is wearing the AR device 328, causes the AR device 328 to present a messaging user interface 312 of the messaging application. The AR device 328 can present the messaging user interface 312 to the user 302 via its display (e.g., as shown by user 302's field of view 310). In some embodiments, the application is initiated and can be run on the device (e.g., the wrist-wearable device 326, the AR device 328, and/or the HIPD 342) that detects the user input to initiate the application, and the device provides another device operational data to cause the presentation of the messaging application. For example, the wrist-wearable device 326 can detect the user input to initiate a messaging application, initiate and run the messaging application, and provide operational data to the AR device 328 and/or the HIPD 342 to cause presentation of the messaging application. Alternatively, the application can be initiated and run at a device other than the device that detected the user input. For example, the wrist-wearable device 326 can detect the hand gesture associated with initiating the messaging application and cause the HIPD 342 to run the messaging application and coordinate the presentation of the messaging application.

Further, the user 302 can provide a user input provided at the wrist-wearable device 326, the AR device 328, and/or the HIPD 342 to continue and/or complete an operation initiated at another device. For example, after initiating the messaging application via the wrist-wearable device 326 and while the AR device 328 presents the messaging user interface 312, the user 302 can provide an input at the HIPD 342 to prepare a response (e.g., shown by the swipe gesture performed on the HIPD 342). The user 302's gestures performed on the HIPD 342 can be provided and/or displayed on another device. For example, the user 302's swipe gestures performed on the HIPD 342 are displayed on a virtual keyboard of the messaging user interface 312 displayed by the AR device 328.

In some embodiments, the wrist-wearable device 326, the AR device 328, the HIPD 342, and/or other communicatively coupled devices can present one or more notifications to the user 302. The notification can be an indication of a new message, an incoming call, an application update, a status update, etc. The user 302 can select the notification via the wrist-wearable device 326, the AR device 328, or the HIPD 342 and cause presentation of an application or operation associated with the notification on at least one device. For example, the user 302 can receive a notification that a message was received at the wrist-wearable device 326, the AR device 328, the HIPD 342, and/or other communicatively coupled device and provide a user input at the wrist-wearable device 326, the AR device 328, and/or the HIPD 342 to review the notification, and the device detecting the user input can cause an application associated with the notification to be initiated and/or presented at the wrist-wearable device 326, the AR device 328, and/or the HIPD 342.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 328 can present to the user 302 game application data and the HIPD 342 can use a controller to provide inputs to the game. Similarly, the user 302 can use the wrist-wearable device 326 to initiate a camera of the AR device 328, and the user can use the wrist-wearable device 326, the AR device 328, and/or the HIPD 342 to manipulate the image capture (e.g., zoom in or out, apply filters) and capture image data.

While an AR device 328 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 3C-1 and 3C-2, the user 302 is shown wearing the wrist-wearable device 326 and an MR device 332 (e.g., a device capable of providing either an entirely VR experience or an MR experience that displays object(s) from a physical environment at a display of the device) and holding the HIPD 342. In the third AR system 300c, the wrist-wearable device 326, the MR device 332, and/or the HIPD 342 are used to interact within an MR environment, such as a VR game or other MR/VR application. While the MR device 332 presents a representation of a VR game (e.g., first MR game environment 320) to the user 302, the wrist-wearable device 326, the MR device 332, and/or the HIPD 342 detect and coordinate one or more user inputs to allow the user 302 to interact with the VR game.

In some embodiments, the user 302 can provide a user input via the wrist-wearable device 326, the MR device 332, and/or the HIPD 342 that causes an action in a corresponding MR environment. For example, the user 302 in the third MR system 300c (shown in FIG. 3C-1) raises the HIPD 342 to prepare for a swing in the first MR game environment 320. The MR device 332, responsive to the user 302 raising the HIPD 342, causes the MR representation of the user 322 to perform a similar action (e.g., raise a virtual object, such as a virtual sword 324). In some embodiments, each device uses respective sensor data and/or image data to detect the user input and provide an accurate representation of the user 302's motion. For example, image sensors (e.g., SLAM cameras or other cameras) of the HIPD 342 can be used to detect a position of the HIPD 342 relative to the user 302's body such that the virtual object can be positioned appropriately within the first MR game environment 320; sensor data from the wrist-wearable device 326 can be used to detect a velocity at which the user 302 raises the HIPD 342 such that the MR representation of the user 322 and the virtual sword 324 are synchronized with the user 302's movements; and image sensors of the MR device 332 can be used to represent the user 302's body, boundary conditions, or real-world objects within the first MR game environment 320.

In FIG. 3C-2, the user 302 performs a downward swing while holding the HIPD 342. The user 302's downward swing is detected by the wrist-wearable device 326, the MR device 332, and/or the HIPD 342 and a corresponding action is performed in the first MR game environment 320. In some embodiments, the data captured by each device is used to improve the user's experience within the MR environment. For example, sensor data of the wrist-wearable device 326 can be used to determine a speed and/or force at which the downward swing is performed and image sensors of the HIPD 342 and/or the MR device 332 can be used to determine a location of the swing and how it should be represented in the first MR game environment 320, which, in turn, can be used as inputs for the MR environment (e.g., game mechanics, which can use detected speed, force, locations, and/or aspects of the user 302's actions to classify a user's inputs (e.g., user performs a light strike, hard strike, critical strike, glancing strike, miss) or calculate an output (e.g., amount of damage)).

FIG. 3C-2 further illustrates that a portion of the physical environment is reconstructed and displayed at a display of the MR device 332 while the MR game environment 320 is being displayed. In this instance, a reconstruction of the physical environment 346 is displayed in place of a portion of the MR game environment 320 when object(s) in the physical environment are potentially in the path of the user (e.g., a collision with the user and an object in the physical environment are likely). Thus, this example MR game environment 320 includes (i) an immersive VR portion 348 (e.g., an environment that does not have a corollary counterpart in a nearby physical environment) and (ii) a reconstruction of the physical environment 346 (e.g., table 350 and cup 352). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 326, the MR device 332, and/or the HIPD 342 are described as detecting user inputs, in some embodiments, user inputs are detected at a single device (with the single device being responsible for distributing signals to the other devices for performing the user input). For example, the HIPD 342 can operate an application for generating the first MR game environment 320 and provide the MR device 332 with corresponding data for causing the presentation of the first MR game environment 320, as well as detect the user 302's movements (while holding the HIPD 342) to cause the performance of corresponding actions within the first MR game environment 320. Additionally or alternatively, in some embodiments, operational data (e.g., sensor data, image data, application data, device data, and/or other data) of one or more devices is provided to a single device (e.g., the HIPD 342) to process the operational data and cause respective devices to perform an action associated with processed operational data.

In some embodiments, the user 302 can wear a wrist-wearable device 326, wear an MR device 332, wear smart textile-based garments 338 (e.g., wearable haptic gloves), and/or hold an HIPD 342 device. In this embodiment, the wrist-wearable device 326, the MR device 332, and/or the smart textile-based garments 338 are used to interact within an MR environment (e.g., any AR or MR system described above in reference to FIGS. 3A-3B). While the MR device 332 presents a representation of an MR game (e.g., second MR game environment 320) to the user 302, the wrist-wearable device 326, the MR device 332, and/or the smart textile-based garments 338 detect and coordinate one or more user inputs to allow the user 302 to interact with the MR environment.

In some embodiments, the user 302 can provide a user input via the wrist-wearable device 326, an HIPD 342, the MR device 332, and/or the smart textile-based garments 338 that causes an action in a corresponding MR environment. In some embodiments, each device uses respective sensor data and/or image data to detect the user input and provide an accurate representation of the user 302's motion. While four different input devices are shown (e.g., a wrist-wearable device 326, an MR device 332, an HIPD 342, and a smart textile-based garment 338) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 338) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 338 can be used in conjunction with an MR device and/or an HIPD 342.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 3A-3C-2 provided above are intended to augment the description provided in reference to FIGS. 1A-2. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”' can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer-readable storage medium including instructions that, when executed by one or more processors of an augmented-reality headset, cause the augmented- reality headset to perform:
responsive to receiving, at an artificial-reality (AR) headset, a user input requesting an augmented-reality-assisted interaction to be directed to a physical surface:
presenting, via the AR headset, an augmented-reality interaction guide that is (i) co-located with the physical surface, and (ii) presented with a first orientation relative to an orientation of the AR headset;
obtaining data, via the AR headset, indicating that a user interaction has been performed that causes a modification to the physical surface; and
responsive to obtaining additional data, via the AR headset, indicating movement of the physical surface relative to the orientation of the AR headset:
presenting, via the AR headset, the augmented-reality interaction guide so that it appears at the physical surface with a second orientation relative to the orientation of the AR headset, different than the first orientation, wherein the second orientation is determined based on:
the modification to the physical surface caused by the user interaction at the physical surface, and
the movement of the physical surface relative to the orientation of the AR headset.

2. The non-transitory computer-readable storage medium of claim 1, wherein the instructions, when executed by the one or more processors of the augmented-reality headset, further cause the augmented-reality headset to perform:
before presenting the augmented-reality interaction guide:
obtaining object data about the physical surface and/or a physical object having the physical surface; and
identifying the augmented-reality interaction guide based on the object data about the physical surface and/or the physical object.

3. The non-transitory computer-readable storage medium of claim 2, wherein the instructions, when executed by the one or more processors of the augmented-reality headset, further cause the augmented-reality headset to perform:
after identifying the augmented-reality interaction guide based on the object data:
presenting, via the AR headset, an interaction guide selector user interface element that includes the augmented-reality interaction guide.

4. The non-transitory computer-readable storage medium of claim 1, wherein the instructions, when executed by the one or more processors of the augmented-reality headset, further cause the augmented-reality headset to perform:
responsive to another user input, directed to the physical surface, to cause a different augmented-reality-assisted interaction to be directed to the physical surface:
determining that the physical surface is unsuitable for the different augmented-reality-assisted interaction; and
based on determining that the physical surface is unsuitable for the different augmented-reality interaction, forgoing causing the different augmented-reality-assisted interaction to be directed to the physical surface.

5. The non-transitory computer-readable storage medium of claim 4, wherein forgoing causing the different augmented-reality-assisted interaction to be performed at the physical surface includes forgoing presenting a respective augmented-reality interaction guide, corresponding to the different augmented-reality interaction, to appear at the physical surface.

6. The non-transitory computer-readable storage medium of claim 5, wherein the instructions, when executed by the one or more processors of the augmented-reality headset, further cause the augmented-reality headset to perform:
in accordance with forgoing presenting the respective augmented-reality interaction guide based on determining that the physical surface is unsuitable for of the physical surface for the different augmented-reality-assisted interaction:
presenting an indication that the physical surface is unsuitable for the different augmented-reality-assisted interaction.

7. The non-transitory computer-readable storage medium of claim 1, wherein the augmented-reality-assisted interaction includes one or more of: (i) painting, (ii) calligraphy, (iii) graffiti, and/or (iv) cut-out patterns.

8. The non-transitory computer-readable storage medium of claim 1, wherein the instructions, when executed by the one or more processors of the augmented-reality headset, further cause the augmented-reality headset to perform:
determining, based on obtaining additional surface data about the physical surface, that a portion of the augmented-reality-assisted interaction facilitated by the augmented-reality interaction guide has been completed; and
based on determining that the portion of the augmented-reality-assisted interaction has been completed, adjusting the presenting of the augmented-reality interaction guide to present respective visual elements corresponding to a different portion of the augmented-reality interaction guide.

9. A method, comprising:
responsive to receiving, at an artificial-reality (AR) headset, a user input requesting an augmented-reality-assisted interaction to be directed to a physical surface:
presenting, via the AR headset, an augmented-reality interaction guide that is (i) co-located with the physical surface, and (ii) presented with a first orientation relative to an orientation of the AR headset;
obtaining data, via the AR headset, indicating that a user interaction has been performed that causes a modification to the physical surface; and
responsive to obtaining additional data, via the AR headset, indicating movement of the physical surface relative to the orientation of the AR headset:
presenting, via the AR headset, the augmented-reality interaction guide so that it appears at the physical surface with a second orientation relative to the orientation of the AR headset, different than the first orientation, wherein the second orientation is determined based on:
the modification to the physical surface caused by the user interaction at the physical surface, and
the movement of the physical surface relative to the orientation of the AR headset.

10. The method of claim 9, further comprising:
before presenting the augmented-reality interaction guide:
obtaining object data about the physical surface and/or a physical object having the physical surface; and
identifying the augmented-reality interaction guide based on the object data about the physical surface and/or the physical object.

11. The method of claim 10, further comprising:
after identifying the augmented-reality interaction guide based on the object data:
presenting, via the AR headset, an interaction guide selector user interface element that includes the augmented-reality interaction guide.

12. The method of claim 9, further comprising:
responsive to another user input, directed to the physical surface, to cause a different augmented-reality-assisted interaction to be directed to the physical surface:
determining that the physical surface is unsuitable for the different augmented-reality-assisted interaction; and
based on determining that the physical surface is unsuitable for the different augmented-reality interaction, forgoing causing the different augmented-reality-assisted interaction to be directed to the physical surface.

13. The method of claim 12, wherein forgoing causing the different augmented-reality-assisted interaction to be performed at the physical surface includes forgoing presenting a respective augmented-reality interaction guide, corresponding to the different augmented-reality interaction, to appear at the physical surface.

14. The method of claim 13, further comprising:
in accordance with forgoing presenting the respective augmented-reality interaction guide based on determining that the physical surface is unsuitable for of the physical surface for the different augmented-reality-assisted interaction:
presenting an indication that the physical surface is unsuitable for the different augmented-reality-assisted interaction.

15. The method of claim 9, wherein the augmented-reality-assisted interaction includes one or more of: (i) painting, (ii) calligraphy, (iii) graffiti, and/or (iv) cut-out patterns.

16. A system, comprising:
an augmented-reality headset, comprising one or more processors and memory, the memory comprising instructions which, when executed by the one or more processors, cause performance of:
responsive to receiving, at an artificial-reality (AR) headset, a user input requesting an augmented-reality-assisted interaction to be directed to a physical surface:
presenting, via the AR headset, an augmented-reality interaction guide that is (i) co-located with the physical surface, and (ii) presented with a first orientation relative to an orientation of the AR headset;
obtaining data, via the AR headset, indicating that a user interaction has been performed that causes a modification to the physical surface; and
responsive to obtaining additional data, via the AR headset, indicating movement of the physical surface relative to the orientation of the AR headset:
presenting, via the AR headset, the augmented-reality interaction guide so that it appears at the physical surface with a second orientation relative to the orientation of the AR headset, different than the first orientation, wherein the second orientation is determined based on:
the modification to the physical surface caused by the user interaction at the physical surface, and
the movement of the physical surface relative to the orientation of the AR headset.

17. The system of claim 16, wherein the instructions, when executed by the one or more processors, further cause performance of:
before presenting the augmented-reality interaction guide:
obtaining object data about the physical surface and/or a physical object having the physical surface; and
identifying the augmented-reality interaction guide based on the object data about the physical surface and/or the physical object.

18. The system of claim 17, wherein the instructions, when executed by the one or more processors, further cause performance of:
after identifying the augmented-reality interaction guide based on the object data:
presenting, via the AR headset, an interaction guide selector user interface element that includes the augmented-reality interaction guide.

19. The system of claim 16, wherein the instructions, when executed by the one or more processors, further cause performance of:
responsive to another user input, directed to the physical surface, to cause a different augmented-reality-assisted interaction to be directed to the physical surface:
determining that the physical surface is unsuitable for the different augmented-reality-assisted interaction; and
based on determining that the physical surface is unsuitable for the different augmented-reality interaction, forgoing causing the different augmented-reality-assisted interaction to be directed to the physical surface.

20. The system of claim 19, wherein forgoing causing the different augmented-reality-assisted interaction to be performed at the physical surface includes forgoing presenting a respective augmented-reality interaction guide, corresponding to the different augmented-reality interaction, to appear at the physical surface.
